(19) United States
(12) Patent Application Publication
(10) Pub. No.: US 2007/0152931 A1
(43) Pub. Date: Jul. 5, 2007

(54) LCD Driver

(75) Inventors: Peter H. Xiao, San Jose, CA (US); Jemm Y. Liang, San Jose, CA (US)

Correspondence Address: PARSONS HSUE & DE RUNTZ LLP, 595 MARKET STREET, SUITE 1900, SAN FRANCISCO, CA, 94105, US

(73) Assignee: JPS Group Holdings, Ltd., Road Town (VG)

(21) Appl. No.: 11/678,036

(22) Filed: Feb. 22, 2007

Related U.S. Application Data
(62) Division of application No. 10/665,810, filed on Sep. 19, 2003.
(60) Provisional application No. 60/416,855, filed on Oct. 8, 2002.

(51) Int. Cl. G09G 3/36

(52) U.S. Cl. 345/87

(57) ABSTRACT

A capacitor divider comprising a plurality of capacitors is used for driving liquid crystal displays. The use of capacitor dividers reduces power consumption, which would be desirable for portable devices. Power consumption is reduced in some embodiments where no static current would flow in the divider.

### CROSS REFERENCE TO RELATED APPLICATIONS

This application is a divisional of application Ser. No. 10/665,810 filed on Sep. 19, 2003, which claims the benefit of Provisional Application No. 60/416,855 filed Oct. 8, 2002 which applications are incorporated herein by reference in their entirety.

### BACKGROUND OF THE INVENTION

This invention relates in general to liquid crystal displays (LCDs) and, in particular, to an LCD driver.

FIG. 1 is a schematic view of a LCD panel and its n row electrodes labeled COM 1, . . . COM n in FIG. 1, and k column electrodes shown as vertical rectangles labeled SEG 1˜SEGk in FIG. 1. Not shown in FIG. 1 (to simplify the figure) is a layer of liquid crystal material between the row and column electrodes. When an appropriate voltage is applied across a particular row and a particular column electrode, a portion of the liquid crystal layer between the particular row and column electrodes where they overlap controls the light transmission or reflective properties of such portion, where the overlapping portion of each row and each column electrode when viewed in a viewing direction defines a pixel of the LCD panel.

FIG. 2a is a graphical illustration of the Improved Alto-Pleshko (IAPT) waveform for the row (or COM) electrodes and column (or SEG) electrodes. FIG. 2b is a graphical plot of the conventional Alto-Pleshko driving waveform for row (COM) and column (SEG) electrodes. In FIGS. 2a and 2b, voltages labeled VCOM or variations thereof indicate voltage waveforms that are applied to the row electrodes and voltages labeled V_{SEG} or variations thereof indicate voltage waveforms applied to column electrodes. The driving waveforms in FIGS. 2a and 2b are conventional. Referring to FIG. 1 and FIG. 2a, a typical configuration of passive LCD and a conventional driving waveform are illustrated. As demonstrated in FIG. 1, the ith row electrode is connected to a node at voltage V_{COMi}, on one side, and the jth column electrode is connected to a node at voltage V_{SEGj} on the other side. In FIG. 2a, where vertical axis is voltage, and the horizontal axis time, the data signals V_{SEGj} are also drawn as overlapped shaded region over V_{COMi} signal to illustrate relative relationships between these two sets of signals.

The driving waveform demonstrated in FIG. 2a, is known as Improved Alto-Pleshko driving method (Improved APT, or IAPT for brief). The main characteristic is that the COM scanning pulses are “folded” such that the driving total voltage dynamic range is reduced as compared to the plain APT, as show in FIG. 2b. This reduced voltage range is considered to be advantageous in the conventional design technique used in CMOS integrated driver IC, where low MOS transistor break down voltage (caused by thin gate oxide used in fine gate geometry circuits and devices) would otherwise make the circuit design very difficult.

As shown in FIG. 2a, in field 2×N, the voltage that is supplied to the node V_{COMi} that is not being scanned is at V₅, and that applied to the row electrode that is scanned is at voltage V₁. During such field, the column or SEG electrodes are at V₆ or at V₄, depending on the data that is being applied to the column electrodes. In the field 2×N+1, the non-scanning voltage applied to the row electrodes is V₂, and the voltage applied to the row electrode that is being scanned is V₆. In such field, the voltages that are applied to the column or SEG electrodes are at V₀ or V₂, depending on the data that is being applied to such electrodes.

Thus, from the above, in the IAPT driving method, a total of six different electrical potentials are applied to the row and column electrodes. In the conventional APT driving method shown in FIG. 2b, it will be observed that a total of five different electrical potentials are applied (V_{COM+}, V_{B+}, V0, V_{B-} and V_{COM-}).

FIG. 2c is the graphical illustration of a portion of the IAPT driving waveform of FIG. 2a.

In order to provide the six different electrical potentials used in the IAPT waveform, or the five different electrical potentials used in the APT waveform, it has been found that the provision of two different electrical voltages, V_{LCD} and V_{B}, relative to ground are adequate. The way in which the six different electrical potentials used in the IAPT waveform may be generated by the provision of two different electrical voltages, V_{LCD} and V_{B} is described in U.S. patent application Ser. No. 09/842,988, filed Apr. 26, 2001, which is incorporated hereby in its entirety by reference. Thus, in one conventional LCD driver, a voltage divider is used which includes a number of resistors forming a ladder connected between two nodes at different electrical potentials.

One drawback of such a circuit is that a constant current flows through the power supply and causes constant power dissipation. One of the most frequently heard complaints from users of portable devices, such as portable computers, cellular phones and personal digital assistants is that these devices consume too much power so that one has to constantly charge batteries, which is inconvenient. It is therefore desirable to provide LCD drivers that consume less power in order to extend the battery life. This will be useful for all LCD drivers, and especially for LCDs used in portable devices. To decrease the current consumption in the conventional resistor ladder approach, the only way is to increase the resistance value of the resistors. But this has a negative effect of increasing chip die size. Thus a different approach is desirable.

### SUMMARY OF THE INVENTION

This invention is based on the recognition that power consumption by the LCD driver can be reduced if a capacitor divider comprising a plurality of capacitors is used to provide one or more voltage level(s) and power for driving the LCD. In one embodiment, the capacitor divider comprises a plurality of capacitors that are electrically connected. The capacitor divider may be employed to provide IAPT as well as APT voltage levels or other driving waveform levels. In one embodiment, the control device such as one comprising one or more switches may be employed to connect the divider to row and column electrodes of an LCD to provide suitable voltage levels for driving the electrodes.

### BRIEF DESCRIPTION OF THE DRAWINGS

FIG. 1 is a schematic view of an LCD panel and its row electrodes shown as shaded, horizontal rectangles labeled COM1, . . . COMn and column electrodes shown as vertical rectangles labeled SEG1, . . . SEGk useful for illustrating the invention.

FIG. 2a is a graphical illustration of the conventional improved AltoPleshko (IAPT) waveform for the row or COM electrodes and column or SEG electrodes.

FIG. 2b is a graphical plot of the conventional Alto-Pleshko driving waveform for row (COM) and column (SEG) electrodes.

FIG. 2c is a graphical plot of a portion of the IAPT driving waveform of FIG. 2a.

FIG. 3 is a schematic view of a capacitor divider circuit to illustrate one embodiment of the invention.

FIG. 4 is a schematic view of the capacitor divider circuit with periodic refreshing feature to illustrate another embodiment of the invention.

FIGS. 5a and 5b illustrate two different phases of a capacitor divider to illustrate another embodiment of the invention.

FIG. 6 is a schematic circuit diagram of a capacitor divider circuit for implementing the two phases of operation shown in FIGS. 5a and 5b.

FIG. 7 is a schematic circuit diagram of a capacitor divider to illustrate still another embodiment of the invention.

FIG. 8 is a schematic circuit diagram of a capacitor divider to illustrate one more embodiment of the invention.

FIG. 9 is a schematic view of a capacitor divider to illustrate yet another embodiment of the invention.

FIG. 10 is a graphical plot illustrating electrical potentials for driving an LCD display that comprises three row electrodes R1, R2 and R3, and two column electrodes C1 and C2.

For simplicity in description, identical components are labeled by the same numerals in this application.

### DETAILED DESCRIPTION OF THE EMBODIMENTS

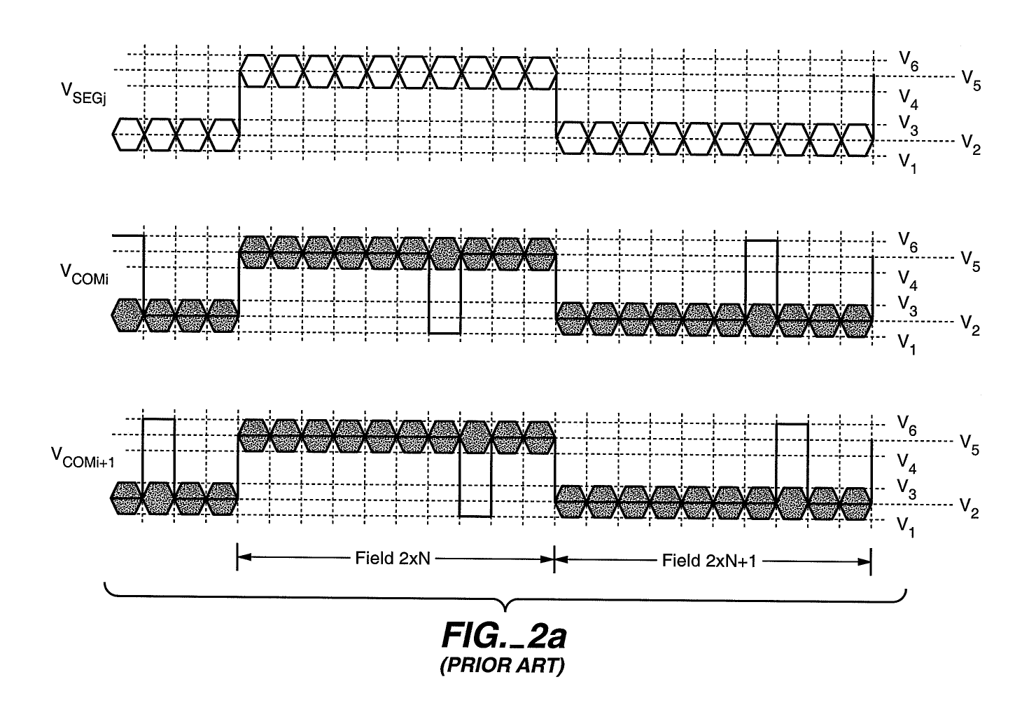

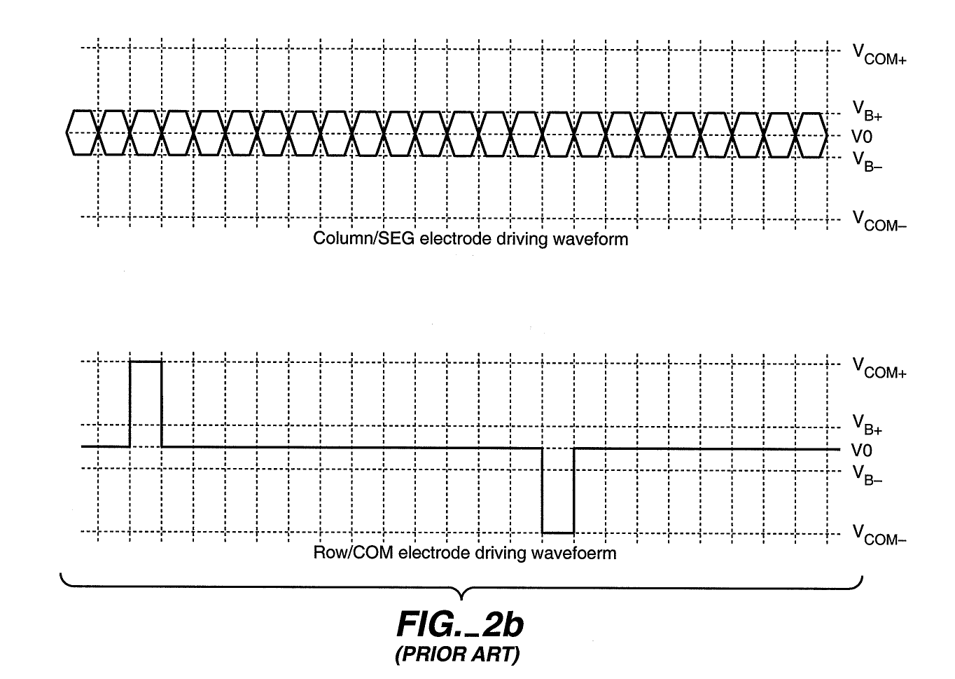

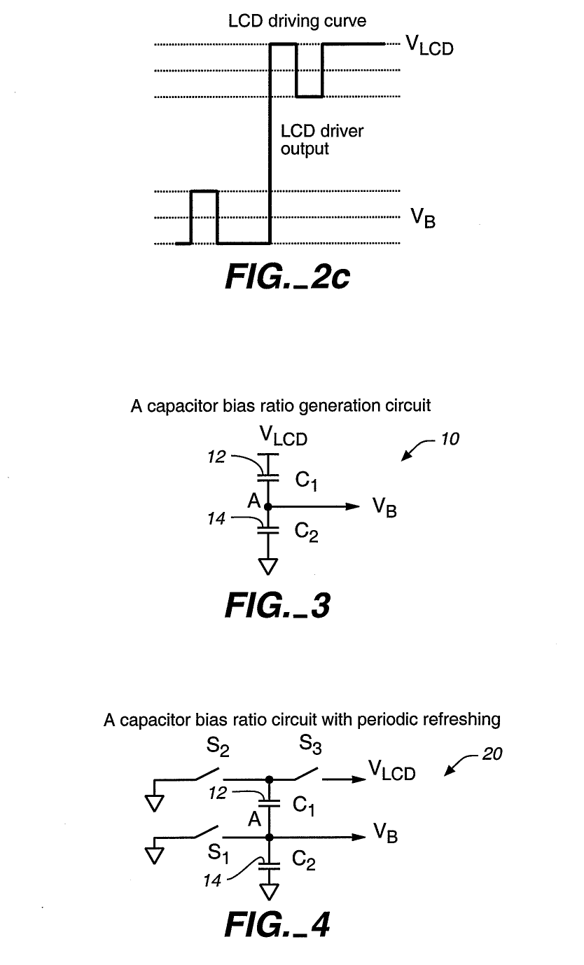

The ratio of V_{LCD} over V_{B} in FIG. 2c is defined as a parameter called bias ratio. Instead of a resistor ladder as used conventionally, a capacitor divider circuit 10 can be employed to generate the bias ratio and to provide the electrical potentials V_{LCD} and V_{B} of FIG. 2c as shown in FIG. 3. The bias ratio BR is

$$BR = \frac{{C}_{2} + {C}_{1}}{{C}_{1}} \qquad Eg . 2$$

where C₁ and C₂ are values of the top capacitor 12 and bottom capacitor 14 in FIG. 3.

Since no static current is required to drive the capacitor divider 10, power is saved through this approach.

One drawback of this approach is that the node A between two capacitors is a floating node (i.e. at a floating electrical potential). Its initial voltage is undetermined. Also over long period of time, the voltage may tend to drift because of capacitor leakage current. These two factors will affect the voltage value at node A.

These two problems are solved by a periodic refreshing circuitry in the capacitor divider 20 as shown in FIG. 4. Three switches S₁, S₂ and S₃ are added to the divider to form an enhanced capacitor divider circuit 20. On clock phase 1, switches S₁ and S₂ are closed and switch S₃ is open. All capacitor terminals are reset to ground and the charges on capacitors 12 and 14 are cleared. On clock phase 2, switches S₁ and S₂ are open and switch S₁ is closed. In this phase, the capacitor circuit 20 can divide the voltage levels accurately and consistently.

Power Saving

Through the use of capacitor dividers, substantially no static current will be passing through the divider circuit. Only the periodic refreshing of these capacitors in the manner described above can cause dynamic power consumption. A typical example will be that refreshing frequency is 80 Hz, V_{LCD}=10 V, C₁=10 pF, C₂=90 pF. Then the current consumption is
I=V_{LCD}*ƒ* C₁* C₂/(C₁+C₂)=7.2nA Eq.3

In the conventional resistor divider approach, where the same V_{LCD} at 10V is divided by the total resistance of 1 Mohm of resistors, the total current would be 10 μA. The power saving of the embodiment in FIG. 4 compared to the conventional resistor divider approach is more than 1000 times.

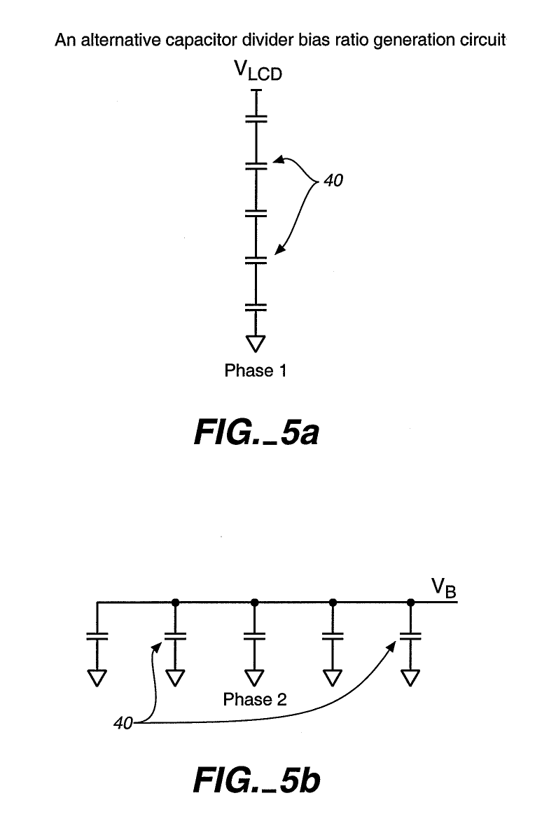

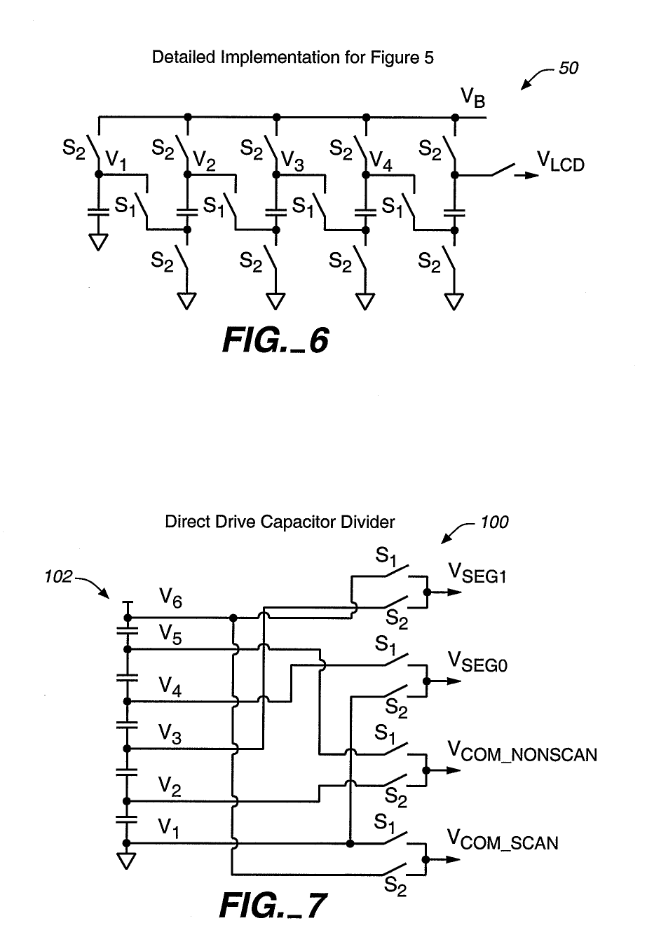

An alternative circuit is available to generate the bias ratio as shown in FIGS. 5a and 5b which illustrate two different phases of a capacitor divider to illustrate another embodiment of the invention. In this circuit, an array of capacitors 40 of substantially equal value is employed. The number of capacitors is preferably equal to the bias ratio. In clock phase 1 (not shown), the capacitors are connected in series between V_{LCD} and ground, so each capacitor has a V_{LCD}/N voltage drop, where N is the number of capacitors in the array. In this phase, the capacitors connected in series into a capacitor divider is used to provide electrical potentials for driving a LCD. In clock phase 2 (not shown), the capacitors are connected in parallel and to a power source for charging the capacitors. When N is selected to be bias ratio, a proper V_{B} voltage is generated for LCD driver.

The circuit illustrated in FIGS. 5a and 5b is particularly useful when the bias ratio is low, e.g. 3 or 4. A small number of capacitors can generate the bias ratio effectively with very little power consumption.

FIG. 6 shows the detailed implementation of the circuit 50 whose operation is illustrated in FIGS. 5a and 5b. In phase 1, all the S1 switches are closed so that the capacitors 40 are connected in series. In phase 2, all the S2 switches are closed. The capacitors are then connected in parallel to generate V_{B}.

FIG. 7 shows the connection between the capacitor divider and four nodes V_{COM}_{_{—}}_{SCAN}, V_{COM}_{_{—}}_{NONSCAN}, V_{SEG0} and V_{SEG1} in a LCD COM/SEG circuit. As will be evident from FIGS. 7 and 2a, when the switches S₁ are closed in FIG. 7 in one phase of operation, the voltage waveforms in field 2×N shown in FIG. 2a will be generated. Where switches S₂ are closed instead in another phase of operation, however, the voltage waveforms of field 2×N+1 will be generated instead.

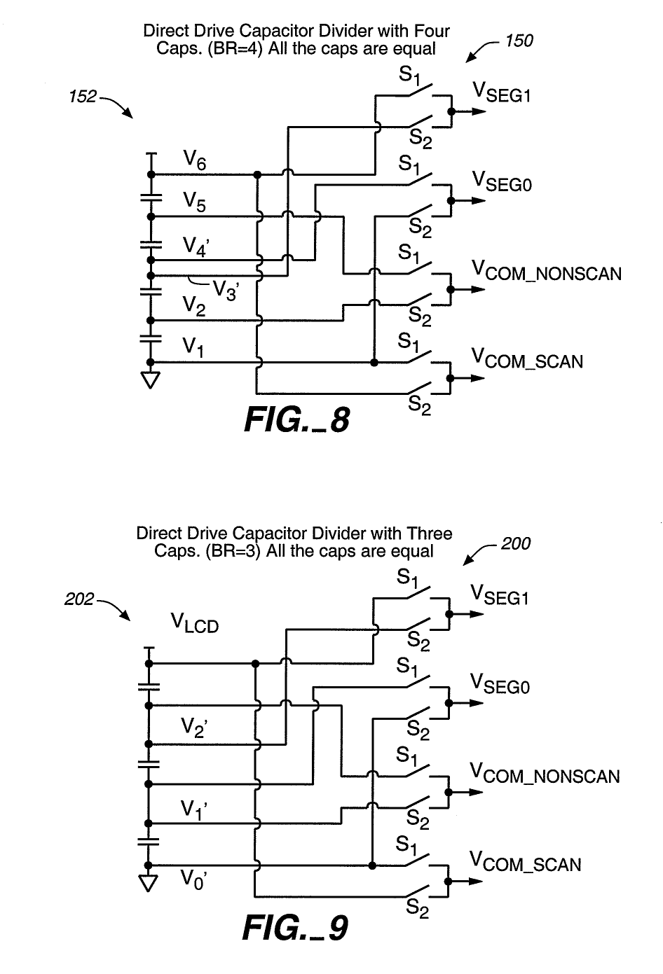

From FIG. 2a, it will be observed that a total of six electrical potential levels have been generated: V₁ through V₆. Instead of generating six different electrical potentials, IAPT voltage waveforms having shapes similar to those of FIG. 2a can be generated by means of a capacitor divider comprising four capacitors instead of five, as illustrated in FIG. 8. Thus, instead of the six electrical potentials of FIGS. 2a and 7, these six electrical potentials can be collapsed so that there is no voltage gap between the two intermediate electrical potentials (V₃ and V₄ of FIG. 2a) to arrive at the same potential V₃′ and V₄′ at the same potential illustrated in FIG. 8. Then voltage waveforms analogous to those of FIG. 2a will be generated by means of the capacitor divider of FIG. 8, but where the two intermediate voltages have now been collapsed into a single electrical potential. Consequently, the voltage waveforms generated will only be at five different electrical potentials instead of six. Therefore, where switches S₁ are closed in one phase of operation, a voltage waveform somewhat similar to that shown in FIG. 2a for the field 2×N will be generated. And when the switches S₂ are closed instead in another phase of operation, a voltage waveform somewhat similar to those in field 2×N+1 would be generated instead.

The five electrical potentials or voltage levels reached in the embodiment of FIG. 8 can be further compressed, so that in reference to the voltage levels in FIG. 2a, so that V₂ and V₄ are substantially at the same voltage level, and V₃ and V₅ are also substantially at the same voltage level. In such instance, the four voltage levels would be V₁, (V₂,V₄), (V₃,V₅) and V₆. These four voltage levels or electrical potentials have now been relabeled V0′, V1′, V2′ and V_{LCD} as shown in FIG. 9. Therefore, as before, where switches S₁ are closed in one phase of operation, a voltage waveform somewhat similar to that shown in FIG. 2a for the field 2×N will be generated. And when the switches S₂ are closed instead in another phase of operation, a voltage waveform somewhat similar to those in field 2×N+1 would be generated instead.

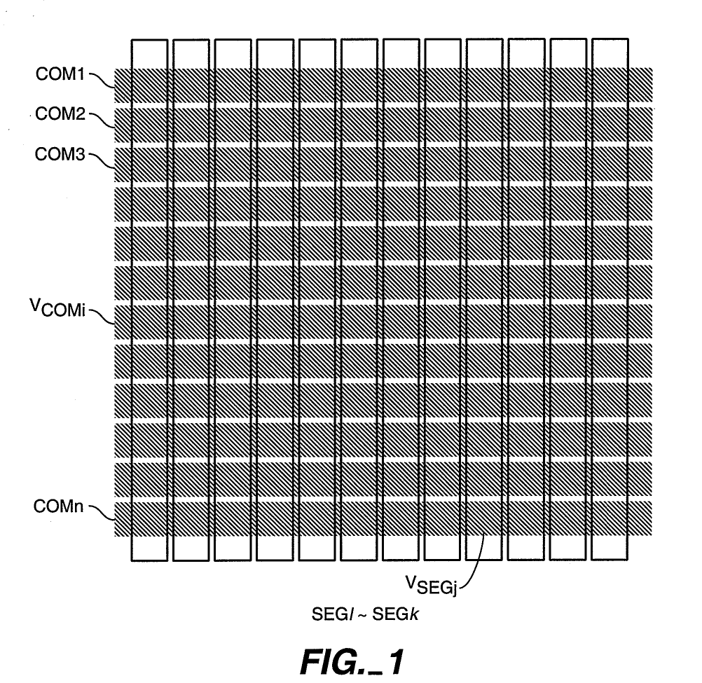

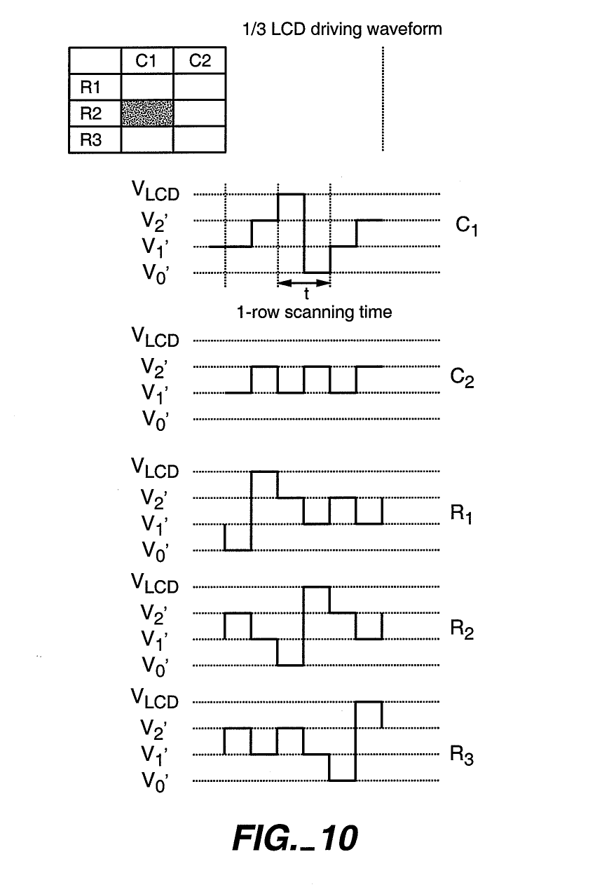

Instead of using the capacitor divider 202 in the manner illustrated in FIG. 9, such divider can also be used for driving the row and column electrodes in a manner quite different from that shown in FIG. 2a. This is illustrated in FIG. 10. Especially where the LCD comprises a small number of row electrodes, the LCD driving waveform of FIG. 10 may be particularly advantageous. This may be useful in applications where small size screen LCDs will be adequate, such as watches, meters, instruments, clocks and other applications. FIG. 10 illustrates electrical potentials for driving an LCD display (not shown but of a similar construction as that in FIG. 1) that comprises three row electrodes R1, R2 and R3, and two column electrodes C1 and C2. The LCD driver 202 is used to provide the same four different electrical potentials as those in FIG. 9 to the row and column electrodes of the LCD. in order for a particular pixel to be turned on in the LCD, the electrical potential or voltage across the overlapping column and row electrode defining such pixel is V_{LCD}-V0′. If the electrical potential between or voltage across the overlapping column and row electrodes is less than such value, then this value would be inadequate to turn on the pixel. Each row is scanned for a time t shown in FIG. 10. Thus, for a row electrode that has been selected for scanning, the voltage applied to such selected row electrode would toggle between V0′ and V_{LCD}, whereas the electrical potentials applied to the row electrodes that have not been selected would toggle between V1′ and V2′. The electrical potentials applied to the column electrodes would also toggle between V0′ and V_{LCD} if on and toggle between V1′ and V2′ if off. Thus, according to the waveforms shown in FIG. 10, the voltage across only one pixel is adequate to turn on such pixel, namely, the pixel where row electrode R2 and column electrode C1 overlap.

Thus, from the above, it will be noted that the capacitor divider may include two, three, four, five or more capacitors in the divider. Such dividers may be employed and configured in different ways for supplying various voltage waveforms and power for driving LCDs.

While the invention has been described above by reference to various embodiments, it will be understood that changes and modifications may be made without departing from the scope of the invention, which is to be defined only by the appended claims and their equivalent. All references referred to herein are incorporated by reference in their entireties.

What is claimed is:

1. An LCD driver comprising:
a capacitor divider which comprises a plurality of capacitors; and
a switching device connecting the divider to row and column electrodes of an LCD, to provide suitable IAPT voltage level(s) for driving the electrodes, wherein the switching device connects the divider to row and column electrodes of a LCD through four nodes: a first and a second column node and a row scanning node and a row non-scanning node.

2. The driver of claim 1, the divider comprising 5 capacitors connected in series between a low and a high reference node, and to one another through a sequence of a first, second, third and fourth connecting node at ascending electrical potentials, wherein the high reference node is at a higher electrical potential than the low reference node.

3. The driver of claim 2, wherein during a first addressing phase, the switching device connects the row non-scanning node to the first connecting node and the row scanning node to the high reference node.

4. The driver of claim 3, wherein during the first addressing phase, the switching device connects the first column node to the low reference node and the second column node to the second connecting node.

5. The driver of claim 4, wherein during a second addressing phase, the switching device connects the row non-scanning node to the fourth connecting node and the row scanning node to the low reference node.

6. The driver of claim 4, wherein during the second addressing phase, the switching device connects the first column node to the third connecting node and the second column node to the high reference node.

7. A method for driving a LCD comprising:
providing a capacitor divider which comprises a plurality of capacitors; and
connecting the divider to row and column electrodes of a LCD, to provide suitable voltage level(s) for driving the electrodes.

8. The method of claim 7, wherein the connecting connects the divider to row and column electrodes of a LCD through four nodes: a first and a second column node and a row scanning node and a row non-scanning node.

9. The method of claim 8, the divider comprising 5 capacitors connected in series between a low and a high reference node, and to one another through a sequence of a first, second, third and fourth connecting node at ascending electrical potentials, wherein the high reference node is at a higher electrical potential than the low reference node, wherein during a first addressing phase, the connecting connects the row non-scanning node to the first connecting node and the row scanning node to the high reference node.

10. The method of claim 9, wherein during the first addressing phase, the connecting connects the first column node to the low reference node and the second column node to the second connecting node.

11. The method of claim 9, wherein during a second addressing phase, the connecting connects the row non-scanning node to the fourth connecting node and the row scanning node to the low reference node.

12. The method of claim 11, wherein during the second addressing phase, the connecting connects the first column node to the third connecting node and the second column node to the high reference node.
